(19) United States
(12) Patent Application Publication
(10) Pub. No.: US 2019/0093855 A1
(43) Pub. Date: Mar. 28, 2019

(54) Lampshade

(71) Applicant: Modern Home Lighting Inc., Dongguan City (CN)

(72) Inventor: Sheng-Chi Chung, Dongguan City (CN)

(21) Appl. No.: 15/715,234

(22) Filed: Sep. 26, 2017

(51) Int. Cl. F21V 1/26; F21V 1/04; F21V 1/12

(52) U.S. Cl. CPC F21V 1/26; F21V 1/12; F21V 1/04

(57) ABSTRACT

A lampshade contains: two connection elements, a covering connecting with a bottom of each of the two opposite connection elements, and two fixing rings. The covering is made of fabric material, and the two fixing rings are made of metal material, and each of the two fixing rings connects with each connection element. Furthermore, the covering has an inner surface of a first end of thereof, and the covering has an outer surface of a second end of the covering connecting with the inner surface of the first end of the covering. Thereby, the lampshade is simplified and is assembled quickly.

### FIELD OF THE INVENTION

The present invention relates to a lampshade which is simplified and is assembled quickly.

### BACKGROUND OF THE INVENTION

A conventional lampshade has a large size, so it is convenient to deliver. In addition, the conventional lampshade has an unchanged appearance.

The present invention has arisen to mitigate and/or obviate the afore-described disadvantages.

### SUMMARY OF THE INVENTION

The primary objective of the present invention is to provide a lampshade which is simplified and is assembled quickly.

To obtain above-mentioned objective, a lampshade provided by a preferred embodiment of the present invention contains: two connection elements, a covering connecting with a bottom of each of the two opposite connection elements, and two fixing rings.

Preferably, the covering is made of fabric material, and the two fixing rings are made of metal material, and each of the two fixing rings connects with each connection element. Furthermore, the covering has an inner surface of a first end of thereof and the covering has an outer surface of a second end of the covering connecting with the inner surface of the first end of the covering.

Preferably, each connection element is a flexible recessed track and has a first adhesion portion formed on the bottom of each connection element; and the covering has two second adhesion portions arranged on two peripheral sides thereof respectively, hence each of the two second adhesion portions adheres with the first adhesion portion of the flexible recessed track; each fixing rings is slidably retained in the flexible recessed track; wherein the covering has a third adhesion portion defined on the inner surface of the first end thereof, and the covering has a fourth adhesion portion formed on the outer surface of the second end thereof so as to adhere with the third adhesion portion.

Preferably, glue is applied on the bottom of the flexible recessed track so as to adhere the flexible recessed track with the covering.

Preferably, the flexible recessed track is made of plastic material, and the plastic material is any one of polyvinyl chloride (PVC), polycarbonate (PC), and polypropylene (PP).

Preferably, each fixing ring is in any one of a circle shape, an oval shape, and a square shape.

Preferably, each fixing ring includes multiple orifices formed thereon, and each connection element has multiple locking tabs arranged thereon so as to retain in the multiple orifices of each fixing ring respectively.

In another preferred embodiment, a lampshade contains: four connection elements, a covering, and two fixing rings.

The covering is made of fabric material and has two of the four connection elements fixed on two peripheral sides of the covering respectively. The two fixing rings is made of metal material and has the other two connection elements respectively so as to connect with the two connection elements of the covering. The covering has an inner surface of a first end of thereof, and the covering has an outer surface of a second end of the covering connecting with the inner surface of the first end of the covering. Each of the four connection elements has a hook-and-loop fastener defined on a central section thereof, and each connection element also has two adhesion portions arranged on two peripheral sides thereof respectively.

### BRIEF DESCRIPTION OF THE DRAWINGS

FIG. 1 is a perspective view showing the exploded components of a lampshade according to a first embodiment of the present invention.

FIG. 2 is a perspective view showing the lampshade being assembled according to the preferred embodiment of the present invention.

FIG. 3 is a perspective view showing the assembly of the lampshade according to the preferred embodiment of the present invention.

FIG. 4 is a perspective view showing the lampshade being assembled according to a second embodiment of the present invention.

FIG. 5 is a perspective view showing the lampshade being assembled according to a third embodiment of the present invention.

### DETAILED DESCRIPTION OF THE PREFERRED EMBODIMENTS

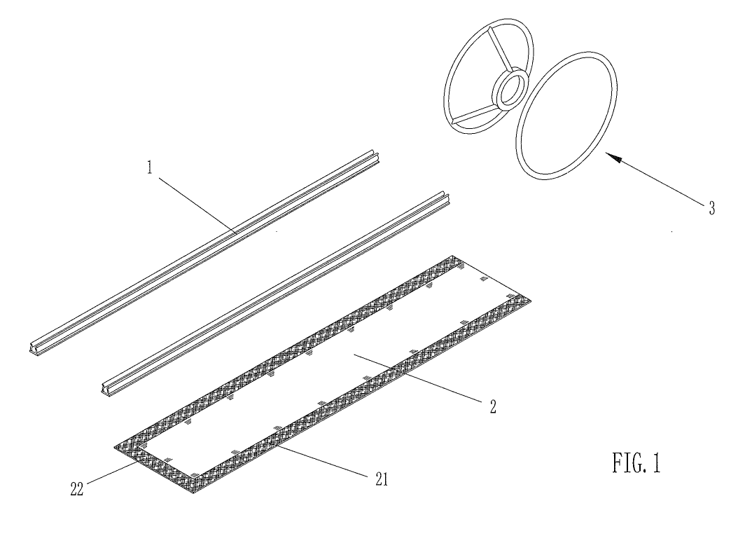

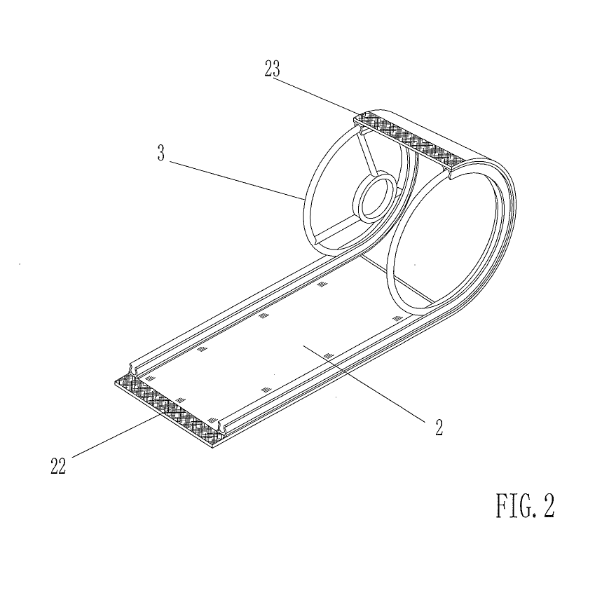

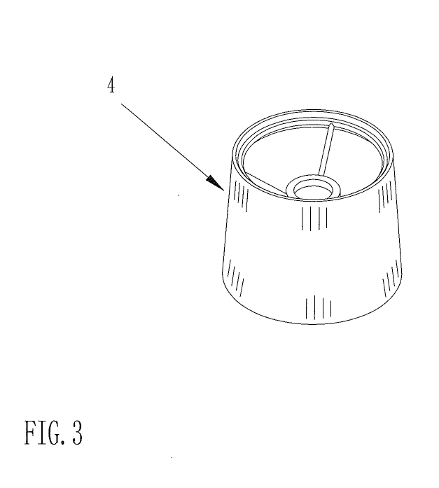

With reference to FIGS. 1 to 3, a lampshade according to a first embodiment of the present invention comprises:

two opposite connection elements 1, and each of two opposite connection elements 1 is a flexible recessed track and has a first adhesion portion 11 formed on a bottom of each connection element 1;

a covering 2 made of fabric material and having two second adhesion portions 21 arranged on two peripheral sides of the covering 2 respectively, hence each of the two second adhesion portions 21 adheres with the first adhesion portion 11 of the flexible recessed track 1, the covering 2 also having a third adhesion portion 22 defined on an inner surface of a first end of the covering 2, and the covering 2 having a fourth adhesion portion 23 formed on an outer surface of a second end of the covering 2;

two fixing rings 3 made of metal material, and each of the two fixing rings 3 being slidably retained in the flexible recessed track 1.

In assembly, the first adhesion portion 11 of the flexible recessed track 1 is adhered with each second adhesion portion 21 of the covering 2, each fixing ring 3 is slid into and is rotated along the flexible recessed track 1 to 360 degrees, and the third adhesion portion 22 of the covering 2 is adhered with the fourth adhesion portion 23 of the covering 2, hence the lampshade 4 is simplified and is assembled quickly.

Preferably, glue is applied on the bottom of each flexible recessed track 1 so as to adhere the flexible recessed track 1 with the covering 2.

Preferably, the flexible recessed track 1 is made of plastic material, and the plastic material is any one of polyvinyl chloride (PVC), polycarbonate (PC), and polypropylene (PP).

Preferably, each fixing ring 3 is in any one of a circle shape, an oval shape, and a square shape, hence each fixing ring 3 is connected with the covering 2 so as to obtain aesthetic feature of the lampshade 4.

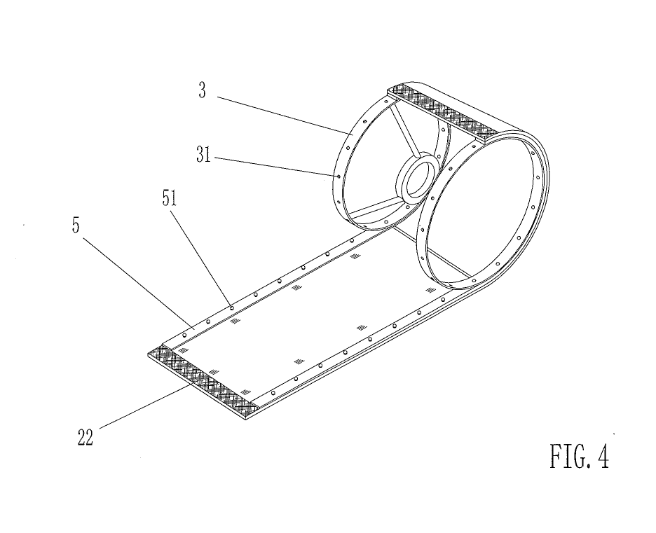

As shown in FIG. 4, a difference of a lampshade of a second embodiment from that of the first embodiment comprises: two opposite connection elements 5 and two fixing rings 3 mating with the two opposite connection elements 5 respectively, wherein each of the two fixing rings 3 includes multiple orifices 31 formed thereon, and each of the two opposite connection elements 5 has multiple locking tabs 51 arranged thereon so as to retaining in the multiple orifices 31 respectively.

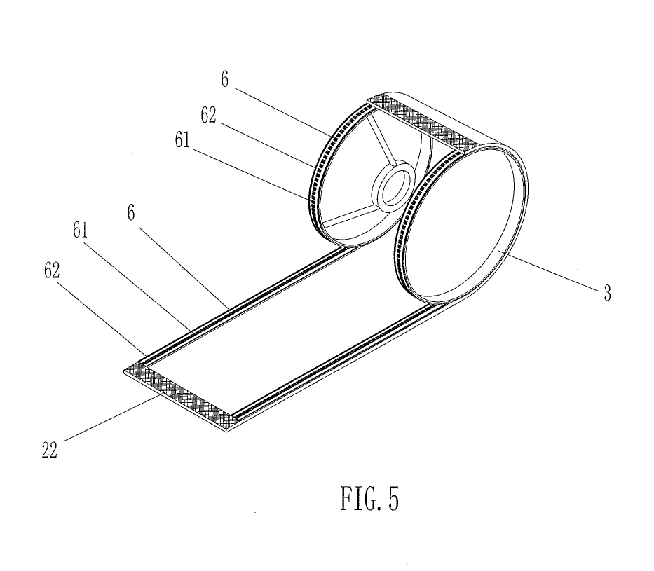

Referring to FIG. 5, a difference of a lampshade of a third embodiment from that of the first embodiment comprises: four connection elements 6, two fixing rings 3, and a covering 2, wherein two of the four connection elements 6 are arranged on the two fixing rings 3 respectively, and the other two connection elements 6 are arranged on two peripheral sides of the covering 2. Each of the four connection elements 6 has a hook-and-loop fastener 61 defined on a central section thereof, and each connection element 6 also has two adhesion portions 62 arranged on two peripheral sides thereof respectively. Thereby, the two fixing rings 3 and the covering 2 are connected together by using the four connection elements, such that the lampshade 4 is assembled securely.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A lampshade comprising:
two connection elements;
a covering made of fabric material and connecting with a bottom of each of the two opposite connection elements; and
two fixing rings made of metal material, and each of the two fixing rings connecting with each connection element;
wherein the covering has an inner surface of a first end of thereof, and the covering has an outer surface of a second end of the covering connecting with the inner surface of the first end of the covering.

2. The lampshade as claimed in claim 1, wherein each connection element is a flexible recessed track and has a first adhesion portion formed on the bottom of each connection element; and the covering has two second adhesion portions arranged on two peripheral sides thereof respectively, hence each of the two second adhesion portions adheres with the first adhesion portion of the flexible recessed track; each fixing rings is slidably retained in the flexible recessed track; wherein the covering has a third adhesion portion defined on the inner surface of the first end thereof, and the covering has a fourth adhesion portion formed on the outer surface of the second end thereof so as to adhere with the third adhesion portion.

3. The lampshade as claimed in claim 1, wherein glue is applied on the bottom of the flexible recessed track so as to adhere the flexible recessed track with the covering.

4. The lampshade as claimed in claim 1, wherein the flexible recessed track is made of plastic material, and the plastic material is any one of polyvinyl chloride (PVC), polycarbonate (PC), and polypropylene (PP).

5. The lampshade as claimed in claim 1, wherein each fixing ring is in any one of a circle shape, an oval shape, and a square shape.

6. The lampshade as claimed in claim 1, wherein each fixing ring includes multiple orifices formed thereon, and each connection element has multiple locking tabs arranged thereon so as to retain in the multiple orifices of each fixing ring respectively.

7. A lampshade comprising:
four connection elements;
a covering made of fabric material and having two of the four connection elements fixed on two peripheral sides of the covering respectively; and
two fixing rings made of metal material and having the other two connection elements respectively so as to connect with the two connection elements of the covering;
wherein the covering has an inner surface of a first end of thereof, and the covering has an outer surface of a second end of the covering connecting with the inner surface of the first end of the covering;
wherein each of the four connection elements has a hook-and-loop fastener defined on a central section thereof, and each connection element also has two adhesion portions arranged on two peripheral sides thereof respectively.

8. The lampshade as claimed in claim 7, wherein each fixing ring is in any one of a circle shape, an oval shape, and a square shape.
